(19) United States
(12) Patent Application Publication
(10) Pub. No.: US 2025/0236942 A1
(43) Pub. Date: Jul. 24, 2025

(54) SUSPENSION PLASMA SPRAY

(71) Applicant: NxEdge, Inc., Boise, ID (US)

(72) Inventors: Jesse Armagost, Boise, ID (US); Kiev Dixon, Boise, ID (US)

(21) Appl. No.: 18/986,305

(22) Filed: Dec. 18, 2024

Related U.S. Application Data
(60) Provisional application No. 63/612,287, filed on Dec. 19, 2023.

(51) Int. Cl. C23C 4/134

(52) U.S. Cl. CPC C23C 4/134

(57) ABSTRACT

A blast nozzle for a thermal spray assembly is provided. The blast nozzle may be a single nozzle or a plurality of blast nozzles arranged symmetrically around the thermal spray axis. The fluid axis from the blast nozzle (or nozzles) is angled with respect to the surface of the substrate to be coated. The angle may be between 0 and 90 degrees, and typically between 40 and 50 degrees, and more typically at about 45 degrees. The fluid from the blast nozzle (or nozzles) is propelled toward the substrate along with a fluid axis that converges with the plasma axis at a convergence point, which may be above the substrate (the near side of the substrate), at the substrate, or below the substrate (the far side of the substrate).

### CROSS-REFERENCE TO RELATED PATENT APPLICATIONS

This application claims the benefit of co-pending U.S. Provisional Patent Application No. 63/612,287, filed Dec. 19, 2023, the entire contents of which are incorporated by reference.

### BACKGROUND

The technology of the present application relates to apparatuses and methods to coat substrates, more particularly, to one or more blast nozzles for a plasma spray systems where the feedstock is either a powder or a particulate suspended in a fluid carrier.

Plasma spray apparatuses and methods are used, among other things, to deposit materials onto a substrate. Early plasma spray apparatuses and methods used a powder feedstock. A gas, such as Argon, stream passes over the powder feedstock to inject particulate into a plasma jet. The particulate material to be coated onto the substrate is carried to the plasma jet that melts the particulate and propels the melted particulate to the surface of the substrate. The melted particulate adheres to the substrate and cools forming a coating. In some embodiments, the process is carried out in an atmosphere and is often referred to as Atmospheric Plasma Spray or APS.

Currently, plasma spray apparatuses and methods sometimes use liquid suspended particulate rather than injecting a powder via an air stream. Injecting a particulate in a liquid is generally referred to as suspension plasma sprays or SPS. Suspended particulate provides a liquid carrier that carries the particulate (or particles) into the plasma jet. A potential benefit of suspended particles is that the particulates or particles in a liquid carrier for SPS can be of a smaller size (diameter) than the particulate carried by the air stream of APS, which has advantages as is generally known in the art. The liquid carrier with the suspension (sometimes referred to as a resin or slurry) is injected to the plasma jet. The plasma jet evaporates the liquid carrier and melts the suspended particle while propelling the particle towards the substrate. The particle adheres to the substrate and cools forming a coating on the substrate.

SPS generally uses less massive (e.g., smaller) particulates (or particles) than APS. As such, the spray distance is often less than APS to provide the need momentum to cause the melted particle to adhere to the substrate. The lesser spray distance of SPS provides that the particulate has a higher velocity than a similar (albeit larger) APS particulate would have when it impacts the substrate. The arrangement often results in cracking, such as vertical cracking, of the coating that is deposited on the substrate. Cracking, whether an APS or an SPS process, can result in unacceptable coatings, especially depending on the end use of the coated substrate. For example, a certain amount of cracking may be permitted for certain types of coatings, such as coatings to provide thermal barriers, but cracking is generally not acceptable for other coatings, such as corrosion or wear resistance coatings.

Thus, against this background, it would be desirable to provide apparatuses and methods to deposit material on a substrate with reduced cracking.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a thermal spray is provided. The thermal spray comprises a plasma jet, a coating material, and at least one blast nozzle. The thermal spray is configured to receive coating material in a fluid and deliver the coating material to a plasma plume exiting the plasma jet. The plasma plume extends along a plasma axis from the plasma jet to a surface of the substrate. The plasma plume melts at least a portion of the coating material and propels the coating material, melted and un-melted, toward a substrate to be coated. The at least one blast nozzle receives an external media and propels the external media along a media axis that converges with the plasma axis. The media is configured to cool and clean the surface of the substrate and deflect un-melted portions of the coating material.

In some embodiments, the thermal spray is an atmospheric plasma spray. In other embodiments, the thermal spray is a suspension plasma spray.

In some embodiments, the at least one blast nozzle comprises a plurality of blast nozzles. In certain aspects the plurality of blast nozzles may be arranged symmetrically around the plasma axis. The fluid axis from the blast nozzle (or nozzles) is angled with respect to the surface of the substrate to be coated. The angle may be between 0 and 90 degrees, and typically between 40 and 50 degrees, and more typically at about 45 degrees. The fluid from the blast nozzle (or nozzles) is propelled toward the substrate along a fluid axis that converges with the plasma axis at a convergence point. The convergence point may be above the substrate (the near side of the substrate), at the substrate, or below the substrate (the far side of the substrate).

These and other aspects of the present system and method will be apparent after consideration of the Detailed Description and Figures herein.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a diagram of a thermal spray consistent with the technology of the present application.

FIG. 2 is a diagram of a thermal spray consistent with the technology of the present application.

FIG. 3 is a diagram of a thermal spray consistent with the technology of the present application.

FIG. 4 is a diagram of a thermal spray consistent with the technology of the present application.

FIG. 5 is a diagram of a thermal spray consistent with the technology of the present application.

FIG. 6 is a diagram of a coated substrate coated with technology consistent with the technology of the present application.

FIG. 7 is a graph of the temperature of the substrate over time as the substrate of FIG. 6 is coated.

FIG. 8 is a graph of the deposition rate as the thermal spray distance changes as the substrate of FIG. 6 is coated.

FIG. 9 is a diagram of a coated substrate coated with the technology consistent with the technology of the present application.

FIG. 10 is a graph of the temperature over time as the substrate of FIG. 9 is coated.

FIG. 11 is a graph of the deposition rate as the spray distance changes as the substrate of FIG. 9 is coated.

FIG. 12 is a diagram of coatings using air and carbon dioxide as the external media consistent with the technology of the present application.

FIG. 13 is a surface view of the coatings of FIG. 12.

FIG. 14 is a diagram of different exemplary coatings on substrates using technology consistent with the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to suspension plasma spray processes (SPS process or SPS processes). However, the technology described herein may be used with applications other than those specifically described herein. For example, the technology of the present application may be applicable to atmospheric plasma spray processes (APS process or APS processes), other thermal spray processes, or the like. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

With reference to a SPS process, a suspension containing particulates (i.e., material) to coat a substrate is provided in a reservoir. The suspension comprises a liquid carrier suspending particles in the liquid, also known as a slurry. The slurry is injected into a plasma plume from a plasma jet. The plasma jet evaporates the liquid carrier, melts the particulate, and propels the particulates to the substrate where it adheres to the substrate. As mentioned above, SPS has a tendency to cause cracking, such as vertical cracking, in the formed coating. It is believed that the vertical cracking is due to, at least in part, to the residual stresses in the coating and from a mismatch in the coefficient of thermal expansion between the coating and the substrate. Additional stresses may be caused by the phase transformations during the coating process and volume changes as material is added to the coating and cooled. In additional to cracking, not all of the particles injected to the plasma plume are effectively melted by the plasma plume, which may be because the particles are deflected and do not enter a zone in the plasma plume where the particles can be melted. The un-melted particles are propelled by the system to the substrate, where they can adhere to the substrate or previous coating material already adhered to the substate. This results in un-melted particles embedding in the coating and/or substrate. The un-melted particles form irregularities in the coating including layering coatings over un-melted particles.

The cracking, irregularities may be reduced by cooling and cleaning the substrate and the associated coating as the particles are projected to the substrate. A blast nozzle propelling an external media at an angle (other than parallel or perpendicular) towards the impact zone of the plasma jet where the particles impact the substrate. The media may be a fluid (gas or liquid) or a solid. The external media is propelled from the blast nozzle (or nozzles) and, in certain embodiments, forms a blast cone for external media surrounding, in part, the plasma plume. The blast cone deflects particles away from the substrate to inhibit un-melted particles from impacting the coating or the surface of the substrate. The external media that have been implemented successfully include carbon dioxide (a.k.a “dry ice”) and air Carbon dioxide and air just two (2) possible external media. In certain embodiments, the external medial may be water. In certain embodiments, a single blast nozzle may be sufficient to decrease cracking and increase yield for the coated substrates. In other embodiments, a plurality of blast nozzles, forming a blast cone, may be required. A single blast nozzle propelling media may form a blast cone about the plasma plume, but the blast cone would be less effective at deflecting particulate although still effective at cooling and cleaning the surface of the substrate (with or without the coating). If the media from the blast nozzle is a liquid, the plasma plume would extend energy evaporating the liquid of the external media, which would require yet additional enthalpy to be added to the plasma plume.

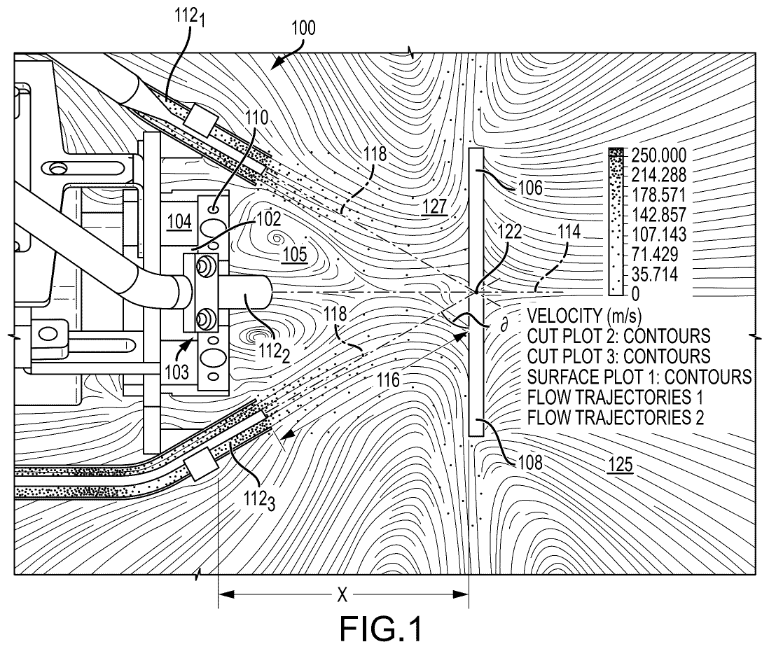

With reference to FIG. 1, a suspension plasma spray 100 consistent with the technology of the present application is provided. The suspension plasma spray 100 is typically provided in a chamber, which is not shown in the present diagram for convenience. The suspension plasma spray 100 includes a cathode 102 and an anode 104. The cathode 102 and the anode 104 functionally operate together to form the plasma jet 103, which forms a plasma plume 105 extending from the plasma jet 103 towards a surface 106 of a substrate 108. The plasma jet 103 generally operates at or above at least 30 kWatts. In certain embodiments, the plasma jet operates at or below about 200 kWatts. In still other embodiments, the plasma jet operates between about 75 k Watts and 110 kWatts or between about 80K and 105 k Watts. The suspension plasma spray 100 also includes a slurry injector 110 (or a powder injector for APS) that is in fluid communication with a reservoir (not specifically shown) of slurry.

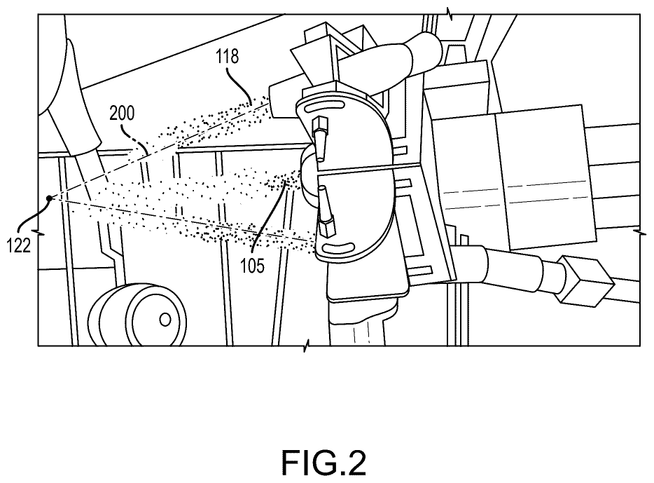

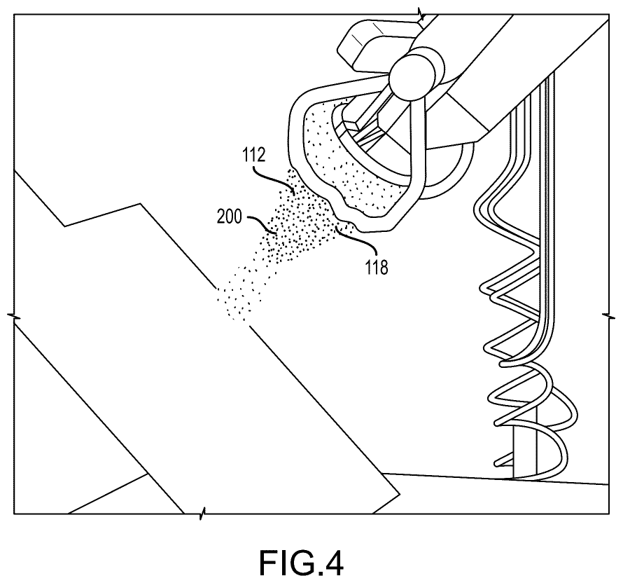

Suspension plasma spray 100 also comprises a plurality of blast nozzles 1121-n. The present exemplary embodiment shows four (4) blast nozzles 11214, which may be generically referred to as blast nozzles 112. While four blast nozzles 112 exist in this exemplary embodiment (of which only three (3) blast nozzles are shown), the technology of the present application includes as few as one (1) blast nozzle 112 as well as many more than four (4) blast nozzles 112. Blast nozzles 1121-4 (of which only blast nozzles 1121-3 are shown in the figure) are placed symmetrically around the plasma plume 105. It is believed symmetrically placing the blast nozzles around the plasma plume forms an effective blast cone 200 (se FIGS. 2-4) about the plasma plume. In some embodiments, the blast nozzles 112 may be formed by a manifold, not specifically shown. In some aspects, the manifold may be a ring type manifold (see FIG. 4).

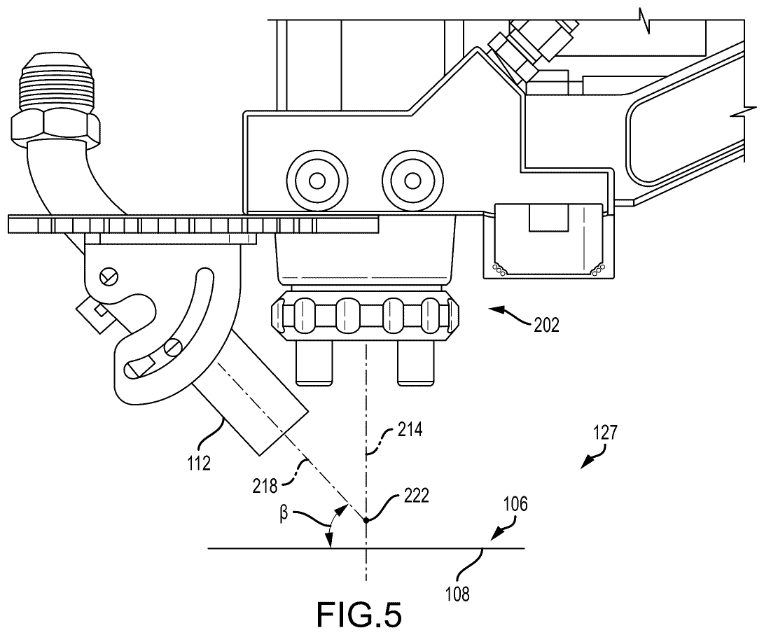

The plasma plume 105 (not specifically shown) would extend along a plasma axis 114, which is shown generally lateral in the diagram and is generally orthogonal to the surface 106 (the plasma axis 114 and fluid axis 118 are best seen in FIG. 5). The blast nozzles 112 propel fluid 116 (external media 116) along a fluid axis 118 at an acute angle α with the surface 106, which acute angle is shown as about 45°, but may be between about 25° and 50°. In certain embodiments, depending on the suspension, the plasma, and the substrate materials, the angles may be approaching either parallel or perpendicular to the plume axis 114. The blast nozzles 112 forms a fluid plume 120 along the fluid axis 118 that converges towards the plasma axis 114 of the plasma plume 105 such that the axes 114 and 118 intersect at a convergence point 122, which is shown as at the substrate 108 in this particular embodiment. Below the substrate may be considered a far side 125 of the substrate 108. Depending on the materials of the suspension, plasma, fluid, and substrate, the convergence point 122 may be below the substrate 108 (or the far side of the substrate), at the substrate 108, or above (or the near side of the substrate) the substrate 108. It is believed the convergence point optimization depends, in part, on the mass of the particles. More massive particles may, in certain instances, pass through the fluid plume such that the convergence point may be above the substrate while less massive particles may, in certain instances, not pass through the fluid plume such that the convergence point may be below the substrate. Below the substrate in this example means on the side of the substrate opposite of the blast nozzle, or the far side. Similarly, above the substrate is in reference to the convergence point 122 being on the side of the substrate with the blast nozzles 112, which may be the near side 127 of the substrate. FIG. 1 only shows fluid plumes 118 from blast nozzles 1121 and 1123 for clarity of the figure.

The plasma jet 103 is a distance X above the substrate. The distance X is dependent on the particles, the gases, and the substrate and is generally adjustable. For SPS, the distance X is generally between about 75 and 105 mm. For APS, the distance X is generally between about 100 and 103 mm. The blast nozzle 112 is angled towards the substate and extends a distance Y along the fluid axis 118 above the substrate. Depending on the angulation of the blast nozzle 112 with respect to the substrate 108, the convergence point will be on the near side, at, or on the far side of the substrate.

FIG. 2 shows the two fluid plumes 118 that converge to a convergence point 122. During use, the fluid plumes 118 interact with the surface 106 of the substrate 108 to clean and cool the coating forming on the substrate. It is believed that cooling the substrate as the coating is applied reduces thermal stresses as the coating is built on the substrate. Further, the blast cone formed by the fluid plumes as they extend to and impact the substrate clears or deflects un-melted particles such that they do not adhere to the coating or the substrate.

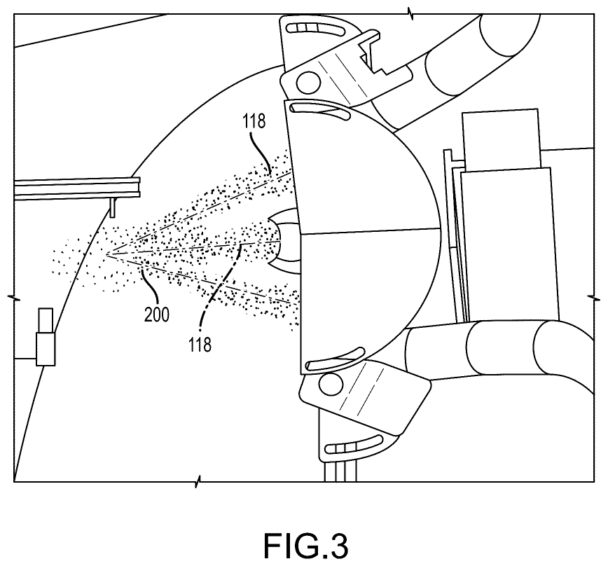

FIG. 2 shows two (2) fluid plumes 118 and a plasma plume 105. The blast cone 200 is arranged about the plasma plume 105. FIG. 3 shows four (4) fluid plumes 118 which obscures the plasma plume. The fluid plumes 118 form the blast cone 200. FIG. 4 shows a fluid plume 118 forming a cone 200 where the plasma plume is obscured. The fluid plumes 118 are sometimes referred to as a blast cone plume. The cone shaped fluid plume is formed by a high number of blast nozzles 112 symmetrically arranged around the plasma plume and/or a manifold forming a ring nozzle 112. The placement of the blast nozzles symmetrically provides a blast cone of fluid that interacts with the plasma plume and the surface of the substrate. The blast cone of fluid, it is believed, interacts with the particles to deflect un-melted particles such that the un-melted particles are deflected away from the substrate, and essentially become waste.

FIG. 5 shows a thermal spray 202 with a single blast nozzle 212. The thermal spray 202 is shown without a plasma plume and without a fluid plume for clarity. The plasma jet 203 would project a plasma plume along the plume axis 214, which is generally vertical in FIG. 5. The plume axis extends generally perpendicular to the surface 106 of the substrate 108.

Similarly, FIG. 5 shows a fluid axis 218 at an acute angle β with respect to the surface 106 of the substrate 108. The fluid axis 218 extends from the blast nozzle 212 to the surface 106 of the substrate 108 and converges towards the plume axis 214 to converge at convergence point 222, which in this exemplary embodiment is above (or on the near side 127) of the surface 106 of the substrate 108. The fluid plume (not shown in FIG. 5) would impact the surface of the substrate to cool and clean the surface as the coating is applied. The convergence, as shown, is above the substrate (or on the near side 127) due in part to the more massive particles used during the implementation of the system of FIG. 5. The fluid plume interacting with the plasma plume above the substrate tends to deflect un-melted particles and cool/clean the surface of the substrate. Multiple nozzles forming a blast cone around the plasma plume ensures that the fluid plume (or “blast cone”) cleans/cools all parts of the substrate being coated.

The particulate generally to coat the substrate may be a number of conventional particulates, such as, for example, aluminum oxide, silicon dioxide, yttrium oxide, yttrium oxyfluoride, yttrium, aluminum, garnet, zirconia, stabilized zirconiz, yttria, or other materials. For SPS, the suspension fluid may be water, an alcohol (such as isopropyl alcohol), ethanol, water and alcohol mixes, or other fluids. In some aspects the suspension fluid may include additives, such as dispersants, 2-phosphobutane and 1,2,4-tricarboxylic acid, polyacrylic acid (PAA), polyvinylpyrrolidone (PVP), polyethylene glycol (PEG), polyvinyl alcohol (PVA or combinations of the same. In one aspect of the technology, polyethyleneimine may be added to the slurry as a dispersant.

The fluid forming the fluid plume may be carbon dioxide, air, or the like.

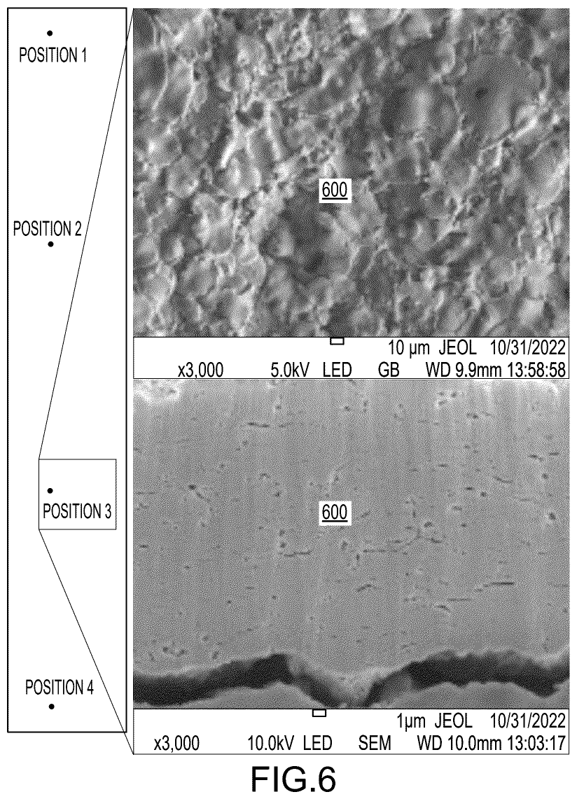

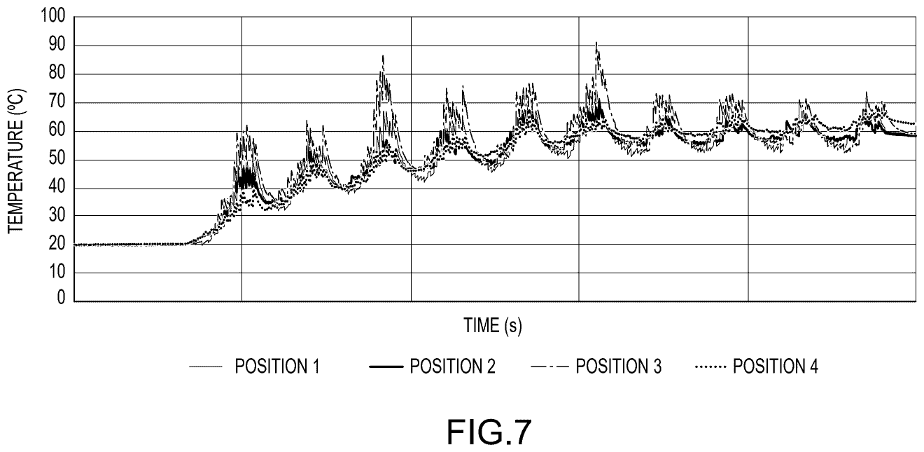

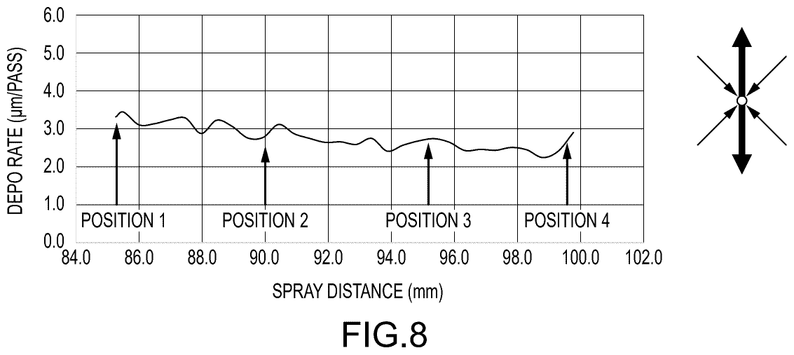

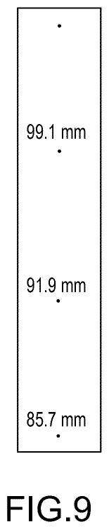

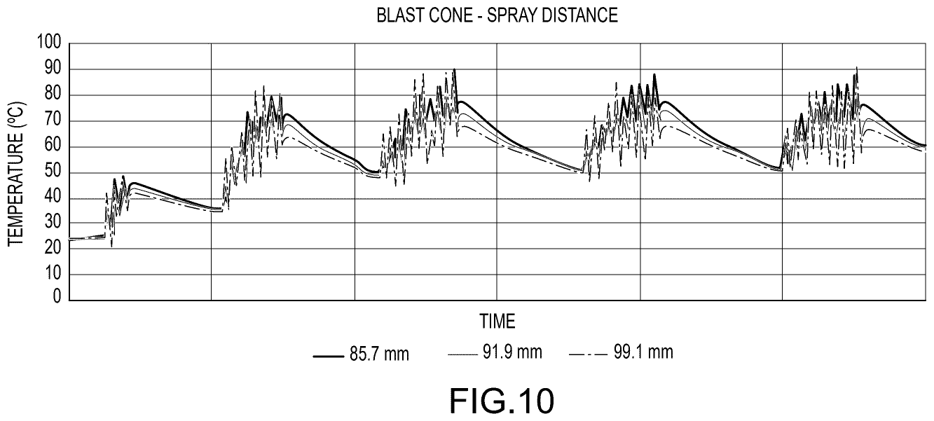

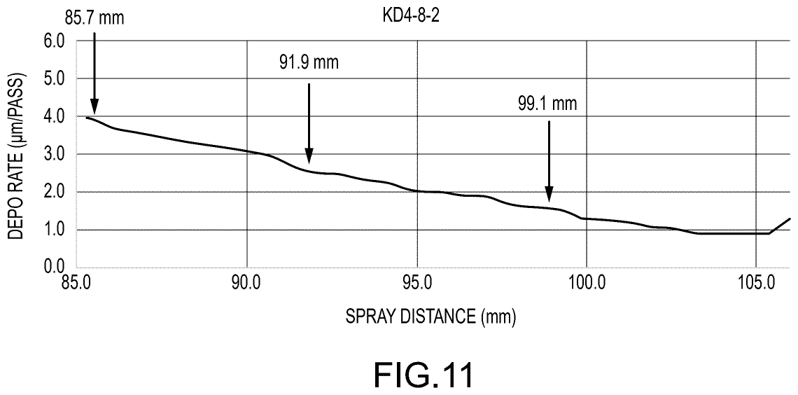

FIG. 6 shows an exemplary coating 600 on a substrate using SPS and blast nozzles 112. The coating 600 is shown as the plasma jet 103 is moved with respect to the distance X. As can be seen, the coating deposited on the surface has a better finish at position 3, which is further from the surface 106 of the substrate 108 than positions 1 and 2, but closer than position 4. The surface finish at position 3 was considered optimal for the purposes of the test. The coloring, which is difficult to see if the figures, of the coating at positions 1 and 2 was indicative of a defect. Moreover, the surface roughness of the coating decreases between position 1 and position 3. At position 3, SPS 100 coated a ceramic on a substrate with an average surface roughness of generally less than about 100 Ra, and in some instances below about 65 Ra. Surface roughness is generally the average change in minimum and maximum thickness over a surface area. As shown by the temperature graph in FIG. 7, the temperature of the substrate increases as the deposition of material occurs, but is generally constant at the various distances X once a steady state operation was achieved. The temperature spikes are generally consistent with when the test thermocouples were under the plasma jets 103. The graph shown in FIG. 8 shows the general deposition rate with the various positions of the plasma jet 103 arranged at a various distances X. FIG. 9 shows another exemplary use of the technology. FIG. 9 shows the coating on the substrate corresponding to the spray distance of the blast cone formed using four (4) blast nozzles 112. FIG. 10 shows a temperature of the blast cone over time with respect to the spray distance. FIG. 11 shows a deposition rate with respect to the spray distance.

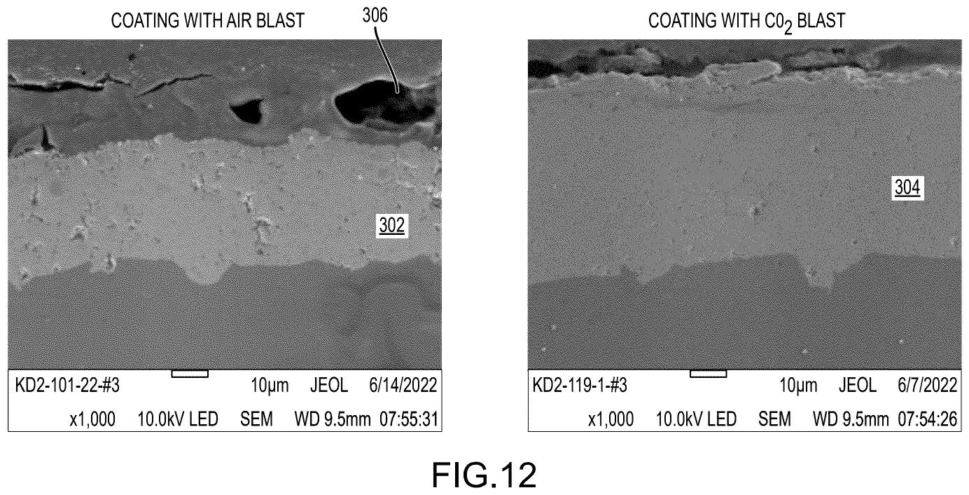

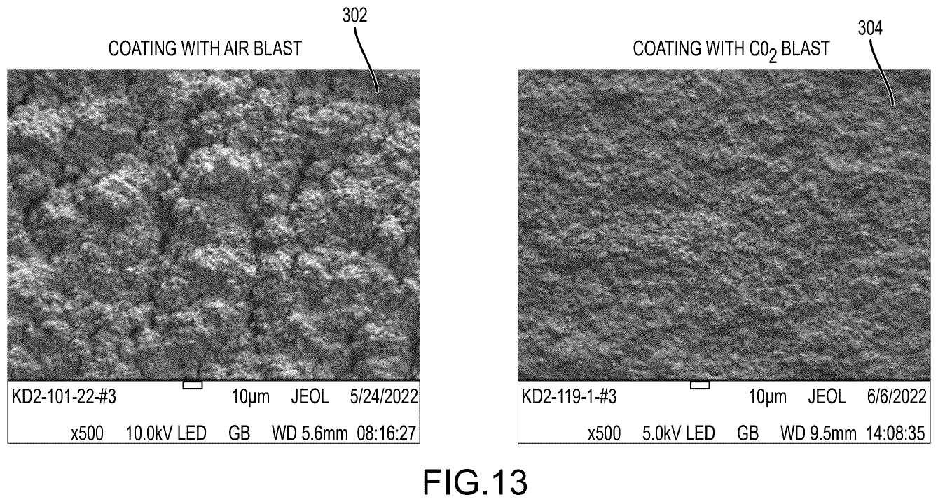

FIG. 12 shows a sample coated substrate where the external media was air v. carbon dioxide. Sample 302 is the sample coated using air as the external media and sample 304 is the sample coated using carbon dioxide as the external media. As can be seen, sample 302 is has some voids 306, which is believed to have been caused by un-melted particulate. The sample 304 has less porosity than the sample 302, which is consistent with carbon dioxide being more effective than air at deflecting un-melted particulate. FIG. 13 shows a top surface view of the sample rather than the cross sectional view of FIG. 12.

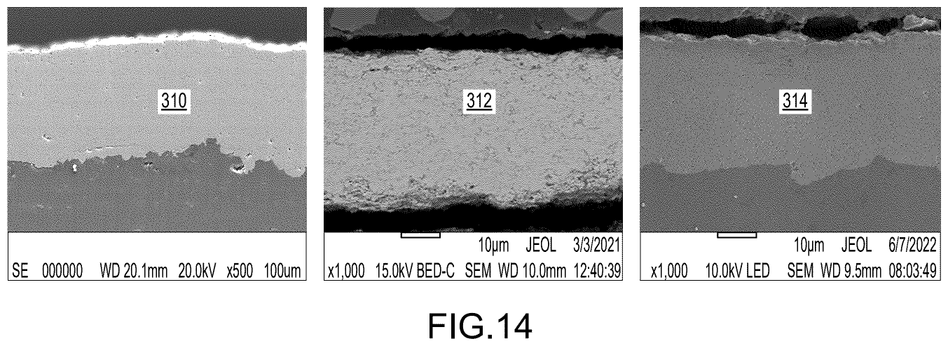

FIG. 14 shows exemplar samples of coating a substrate with yttrium oxide. Sample 310 used carbon dioxide as the external media and a suspension. The coating of the sample 310 is relatively free of porosity and is relatively dense with an average surface roughness of about 60 to 65 Ra (in microns). Sample 312 used air as the external media and a suspension of yttrium oxide in water with a mass ratio of 20/80 water/yttrium oxide. The particulate had an average diameter of about 0.3 microns. The suspension included a dispersant as an additive, which dispersant was polyethylenimine in this particular instance. The coating of the sample 312 has a higher porosity, which was expected due to the use of air instead of carbon dioxide as the external media. The average surface roughness of the sample 312 was generally less than about 40 Ra. Sample 314 used carbon dioxide as the external media and a suspension of yttrium oxide in isopropyl alcohol (IPA), with a mass ratio of about 30 IPA/70 yttrium oxide. The suspension did not contain an additive and the particulate had an average diameter of about 0.3 microns. Sample 314 is relatively free of porosity and is relatively dense with an average surface roughness of about 60 Ra.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A thermal spray apparatus comprising,
a plasma jet comprising at least one anode, at least one cathode, and an injector and configured to propel a plasma plume containing material along a plasma axis towards a surface of a substrate; and
at least one blast nozzle in fluid communication with an external media and configured to propel a fluid plume of the external media along a fluid axis towards the surface of the substrate wherein the fluid axis forms an acute angle with the substrate and wherein the external media is configured to cool the substrate and clean the substrate of un-melted material.

2. The thermal spray of claim 1 wherein the thermal spray is an atmospheric plasma spray (APS).

3. The thermal spray of claim 1 wherein the thermal spray is a suspension plasma spray (SPS).

4. The thermal spray of claim 1 wherein the at least one blast nozzle is a plurality of blast nozzles wherein the plurality of blast nozzles form a blast cone of external media around the plasma plume.

5. The thermal spray of claim 4 wherein the plurality of blast nozzles are symmetrically arranged around the plasma jet.

6. The thermal spray of claim 1 wherein the acute angle is between about 40 and 50 degrees.

7. The thermal spray of claim 6 wherein the acute angle is 45 degrees.

8. The thermal spray of claim 1 wherein the external media is a fluid.

9. The thermal spray of claim 8 wherein the fluid is selected from the group of fluids consisting of air, carbon dioxide, or a combination thereof.

10. The thermal spray of claim 3 wherein the injector injects a slurry comprising a liquid and material into the plasma plume.

11. The thermal spray of claim 10 wherein the liquid is water.

12. The thermal spray of claim 2 wherein the injector injects a carrier gas carrying material into the plasma plume.

13. The thermal spray of claim 4 wherein the plasma axis and the fluid axis converge at a convergence point located at a point selected from the group of points consisting of, a near side of the substrate, at the substrate, or a far side of the substrate.

14. A suspension plasma spray assembly comprising,
a plasma jet comprising at least one anode, at least one cathode, and an injector and configured to propel a plasma plume containing material along a plasma axis towards a surface of a substrate; and
a plurality of blast nozzles arranged symmetrically around the plasma jet in fluid communication with an external media to propel a media plume of the external media along a media axis towards the surface of the substrate wherein the fluid axis forms an acute angle with the substrate and wherein the external media is configured to cool the substrate and clean the substrate of un-melted material.

15. The suspension plasma spray assembly of claim 14 wherein the plurality of blast nozzles comprise at least three blast nozzles.

16. The suspension plasma spray assembly of claim 14 wherein the plurality of blast nozzles propel the media plume that forms a blast cone substantially surrounding the plasma plume.

17. The suspension plasma spray assembly of claim 14 wherein the acute angle is between about 40 and 50 degrees.

18. The suspension plasma spray assembly of claim 14 wherein the media is selected from a group of media consisting of air, carbon dioxide, or a combination thereof.

19. The suspension plasma spray assembly of claim 14 wherein the injector injects a slurry comprising a liquid and the material into the plasma plume.

20. A method of coating a substrate with particulate using a thermal spray, comprising:
injecting particulate carried by a carrier fluid into a plasma plume directed at a surface of a substrate to be coated;
propelling the particulate injected into the plasma plume towards the surface of the substrate to be coated;
melting a portion of the particulate injected into the plasma plume such that the particulate injected into the plasma plume coats the surface of the substrate;
directing a media plume from at least one bast nozzle at an angle towards the surface of the substate such that the plasma plume and the media plume converge; and
removing, by the media plume, un-melted particulate on the surface of the substrate.
